(19) United States
(12) Patent Application Publication
(10) Pub. No.: US 2015/0132483 A1
(43) Pub. Date: May 14, 2015

(54) DISPENSING APPARATUS HAVING SUBSTRATE INVERTER SYSTEM AND ROLLER SYSTEM, AND METHOD FOR DISPENSING A VISCOUS MATERIAL ON A SUBSTRATE

(71) Applicant: Illinois Tool Works Inc., Glenview, IL (US)

(72) Inventor: Dennis G. Doyle, Shrewsbury, MA (US)

(73) Assignee: Illinois Tool Works Inc., Glenview, IL (US)

(21) Appl. No.: 14/080,345

(22) Filed: Nov. 14, 2013

(51) Int. Cl. B05C 13/00

(52) U.S. Cl. CPC B05C 13/00
USPC 427/209; 118/503

(57) ABSTRACT

A dispenser includes a frame, a gantry system coupled to the frame, and a dispensing unit coupled to the gantry system. The dispenser further includes a substrate support assembly coupled to the frame and configured to support the substrate to dispense material on the top surface of the substrate and on the bottom surface of the substrate. The substrate support assembly includes a roller system configured to receive and support the substrate in a dispense position. The substrate support assembly further includes an inverter system coupled to the frame and the roller system. The inverter system is configured to rotate the roller system about an axis that is parallel to the y-axis direction between a first position in which the top surface is in a dispense position and a second position in which the bottom surface is in a dispense position.

### RELATED APPLICATION

This application relates to U.S. patent application Ser. No. ______ entitled DISPENSING APPARATUS HAVING SUBSTRATE INVERTER SYSTEM AND CLAMPING SYSTEM, AND METHOD FOR DISPENSING A VISCOUS MATERIAL ON A SUBSTRATE (Attorney Docket No. C2013-731719), by Dennis G. Doyle and Thomas E. Robinson, filed on even date herewith, and U.S. patent application Ser. No. ______ entitled DISPENSING APPARATUS HAVING TRANSPORT SYSTEM AND METHOD FOR TRANSPORTING A SUBSTRATE WITHIN THE DISPENSING APPARATUS (Attorney Docket No. C2013-731919), by Dennis G. Doyle and Thomas E. Robinson, filed on even date herewith. All of these related applications are incorporated herein by reference.

### BACKGROUND OF THE DISCLOSURE

1. Field of the Invention

The invention relates generally to methods and apparatus for dispensing a viscous material on a substrate, such as a printed circuit substrate.

2. Discussion of Related Art

There are several types of prior art dispensing systems or dispensers used for dispensing metered amounts of liquid or paste for a variety of applications. One such application is the assembly of integrated circuit chips and other electronic components onto circuit board substrates. In this application, automated dispensing systems are used for dispensing dots of liquid epoxy or solder paste, or some other related material, onto circuit boards. Automated dispensing systems are also used for dispensing lines of underfill materials and encapsulents, which mechanically secure components to the circuit board. Underfill materials and encapsulents are used to improve the mechanical and environmental characteristics of the assembly.

FIG. 1 schematically illustrates a known dispenser, which is generally indicated at 10. The dispenser 10 is used to dispense a viscous material (e.g., an adhesive, encapsulent, epoxy, solder paste, underfill material, etc.) or a semi-viscous material (e.g., soldering flux, etc.) onto an electronic substrate 12, such as a printed circuit board or semiconductor wafer. The dispenser 10 may alternatively be used in other applications, such as for applying automotive gasketing material or in certain medical applications. It should be understood that references to viscous or semi-viscous materials, as used herein, are exemplary and intended to be non-limiting. In one embodiment, the dispenser 10 includes first and second dispensing units or heads, generally indicated at 14 and 16, respectively, and a controller 18 to control the operation of the dispenser. Although two dispensing units are shown, it should be understood that one or more dispensing units may be provided.

The dispenser 10 may also include a frame 20 having a base or support 22 for supporting the substrate 12, a dispensing unit gantry 24 movably coupled to the frame 20 for supporting and moving the dispensing units 14, 16, and a weight measurement device or weigh scale 26 for weighing dispensed quantities of the viscous material, for example, as part of a calibration procedure, and providing weight data to the controller 18. A conveyor system (not shown) or other transfer mechanism, such as a walking beam, may be used in the dispenser 10 to control loading and unloading of substrates to and from the dispenser. The gantry 24 can be moved using motors under the control of the controller 18 to position the dispensing units 14, 16 at predetermined locations over the substrate. The dispenser 10 may include a display unit 28 connected to the controller 18 for displaying various information to an operator. There may be an optional second controller for controlling the dispensing units.

Prior to performing a dispensing operation, as described above, the substrate, e.g., the printed circuit board, must be aligned or otherwise in registration with a dispensing unit of the dispenser. The dispenser further includes a vision system 30, which is coupled to a vision system gantry 32 movably coupled to the frame 20 for supporting and moving the vision system. Although shown separately from the dispensing unit gantry 24, the vision system gantry 32 may utilize the same gantry system as the dispensing units 14, 16. As described, the vision system 30 is employed to verify the location of landmarks, known as fiducials or other features and components, on the substrate. Once located, the controller can be programmed to manipulate the movement of one or both of the dispensing units 14, 16 to dispense material on the electronic substrate. The dispense operation may be controlled by the controller 18, which may include a computer system configured to control material dispensers. In another embodiment, the controller 18 may be manipulated by an operator.

In some embodiments, the dispenser 10 may operate as follows. The circuit board may be loaded into the dispenser 10 in a depositing position using the conveyor system. The circuit board is aligned with the dispensing units 14, 16 by using the vision system 30. The dispensing units 14, 16 may then be initiated by the controller 18 to perform a deposit operation in which material is deposited at precise locations on the circuit board. Once the dispensing units 14, 16 have performed a depositing operation, the circuit board may be transported by the conveyor system from the dispenser 10 so that a second, subsequent circuit board may be loaded into the material deposition system. The dispensing units 14, 16 may be constructed to be quickly removed and replaced with other units. The dispenser 10 is capable of dispensing material on only one side of the circuit board.

Sometimes, it is desirable to dispense such materials on both sides of the substrate. One such dispenser is offered by Protec Co., Ltd of Incheon, Korea, and incorporates a substrate support that rotates about an axis that is transverse to a direction that the substrate travels through the dispenser. With this dispenser, belts that engage edges of the substrate move the substrate through the dispenser. With this arrangement, it is difficult to dispense material near edges of the substrate since the belts interfere with the dispensing unit when attempting to dispense material near the edges of the substrate.

### SUMMARY OF THE DISCLOSURE

One aspect of the disclosure is directed to a dispenser for dispensing viscous material on a substrate having a top surface and a bottom surface. In one embodiment, the dispenser comprises a frame, a gantry system coupled to the frame, and a dispensing unit coupled to the gantry system. The gantry system is configured to move the dispensing unit in x-axis, y-axis, and z-axis directions. The dispenser further comprises a substrate support assembly coupled to the frame and configured to support the substrate to dispense material on the top surface of the substrate and on the bottom surface of the substrate. The substrate support assembly includes a roller system configured to receive and support the substrate in a dispense position. The substrate support assembly further includes an inverter system coupled to the frame and the roller system. The inverter system is configured to rotate the roller system about an axis that is parallel to the y-axis direction between a first position in which the top surface is in a dispense position and a second position in which the bottom surface is in a dispense position.

Embodiments of the dispenser further may include configuring the inverter system to move in a z-axis direction. The inverter system may include a rotational drive assembly configured to rotate the roller system. The inverter system further may include a support plate, an elevator plate movably coupled to the support plate, a z-axis drive assembly configured to move the elevator plate in the z-axis direction. The z-axis motion of the elevator plate may cause the engagement and disengagement of the roller system. The z-axis drive assembly may include at least one bearing coupled to the frame by a ball screw, and a motor configured to drive the rotation of the ball screw to move the elevator plate with respect to the support plate. The roller system may include a first roller assembly configured to engage one edge of the substrate and a second roller assembly configured to engage an opposite edge of the substrate. For each of the first roller assembly and the second roller assembly, the rotational drive assembly may include a pivot secured to the roller assembly, a belt coupled to the pivot, and a motor configured to drive the belt to rotate the pivot. Each roller assembly may include a plurality of rollers configured to engage an edge of the substrate and a drive assembly configured to drive the rotation of the rollers. When the rollers engage the edge of the substrate, the substrate is in a top justified position. At least one roller of the plurality of rollers is tapered along a periphery of the roller. Each roller assembly may include a brake assembly configured to prevent the rotation of rollers associated with the roller assembly. The substrate support assembly may include two lanes, a front lane and a rear lane, and wherein the dispenser further comprises an upstream conveyor system configured to deliver substrates to the front and rear lanes of the dispenser. The dispenser further may comprise a downstream conveyor system configured to remove substrates from the front and rear lanes of the dispenser.

Another aspect of the present disclosure is directed to a method of depositing material on a top surface of a substrate and on a bottom surface of the substrate. In one embodiment, the method comprises: delivering the substrate to a substrate support assembly of a dispenser, the substrate support assembly including a roller system configured to receive and support the substrate in a dispense position, and an inverter system coupled to the frame and the roller system, the inverter system being configured to rotate the roller system about an axis that is parallel to the y-axis direction between a first position in which the top surface is in a dispense position and a second position in which the bottom surface is in a dispense position; performing a dispense operation on the top surface of the substrate; rotating the substrate so that the bottom surface of the substrate faces upwardly; performing a dispense operation on the bottom surface of the substrate; and removing the substrate from the substrate support assembly of the dispenser.

Embodiments of the method further may include, prior to rotating the substrate, lowering the substrate, disengaging a drive assembly associated with the roller system, and locking the substrate within the roller system with a brake assembly. The method further may include, prior to performing a dispense operation on the bottom surface of the substrate, raising the substrate, engaging the drive assembly, and unlocking the substrate within the roller system with the brake assembly. Delivering the substrate to the substrate support assembly of the dispenser may include delivering the substrate to the dispense position through a first lane. The method further may comprise delivering another substrate to the substrate support assembly of the dispenser through a second lane. The roller system may include a plurality of rollers configured to engage an edge of the substrate and a drive assembly configured to drive the rotation of the rollers. At least one roller of the plurality of rollers is tapered along a periphery of the roller. The method further may include lowering the substrate after performing the dispense operation on the top surface of the substrate, and raising the substrate after rotating the substrate.

### BRIEF DESCRIPTION OF THE DRAWINGS

For a better understanding of the disclosure, reference is made to the figures which are incorporated herein by reference and in which:

FIG. 1 is a schematic view of a prior art dispenser;

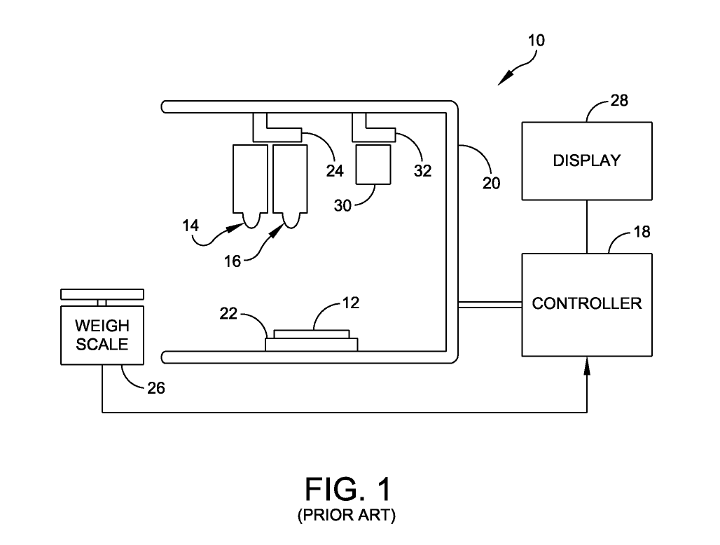

FIG. 2 is a partial top perspective view of a dispenser of an embodiment of the present disclosure with portions removed to better illustrate an inverter system and a clamping system of the dispenser;

FIG. 3 is a top plan view of the dispenser shown in FIG. 2;

FIG. 4 is an enlarged partial top perspective view of the dispenser;

FIG. 5 is another enlarged partial top perspective view of the dispenser having certain components of the dispenser removed to illustrate various aspects of the embodiment;

FIG. 6 is a perspective view of the inverter system;

FIGS. 7A and 7B are schematic top plan views of a roller system of a transport conveyor of the dispenser of an embodiment of the present disclosure;

FIGS. 8A and 8B are schematic top plan views of a roller system having a brake assembly;

FIG. 9 is an enlarged schematic cross sectional view of a drive assembly used to drive the rotation of the roller system shown in FIGS. 8A and 8B; and

FIG. 10 is an enlarged schematic cross sectional view of a drive assembly of another embodiment of the present disclosure.

### DETAILED DESCRIPTION OF THE PREFERRED EMBODIMENTS

For the purposes of illustration only, and not to limit the generality, the disclosure will now be described in detail with reference to the accompanying figures. This disclosure is not limited in its application to the details of construction and the arrangement of components set forth in the following description or illustrated in the drawings. The disclosure is capable of other embodiments and of being practiced or being carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

For purposes of illustration, embodiments of the present disclosure are described below, with reference to a dispenser used to dispense solder paste onto a circuit board. The apparatus and associated methods may also be used in other applications requiring dispensing of other viscous or dispensing materials, such as glues, adhesives, and encapsulants on a variety of substrates. For example, the apparatus may be used to dispense epoxy for use as underfill for chip-scale packages. In certain embodiments, the dispensing units may be of the type offered by Speedline Technologies, Inc. of Franklin, Mass.

The present disclosure is directed to a dispenser including a substrate support assembly having an inverter system provided within the dispenser, which is designed to engage the substrate without interfering with a dispensing unit when dispensing material near edges of the substrate. The dispenser disclosed herein is capable of inverting the substrate, thereby enabling the dispensing unit to dispense material on both sides of the substrate within five millimeters (mm) from the edge of the substrate with an auger-type dispensing unit and within eight mm from the edge of the substrate with a jetter-type dispensing unit. Since traditional transport belts interfere with the dispensing unit in the space above the substrate, the dispenser, in one embodiment, includes a roller system to secure the substrate in a dispense position. To deliver the substrate to the dispense position within the dispenser, the substrate support assembly of the dispenser includes a roller system along with the inverter system. Such a roller system incorporates the use of rollers, preferably tapered rollers. In another embodiment, the dispenser includes a combination of substrate pushers and belts since belts alone cannot completely transport the substrate onto or off of the clamping system of the substrate support assembly. With both the roller system and the clamping system, each system has the ability to dispense close to the edge of the substrate on both the top and bottom surfaces of the substrate.

The present disclosure is directed to the construction of the roller system and the inverter system, and addresses the issues involving the limited space that is available in the dispenser for these systems. The inverter system is configured to rotate the substrate once the substrate is secured in the dispense position by the roller system. In one embodiment, the inverter system is belt driven by a stepper motor, and has a ten-to-one ratio, such that an accurate transport angle is achieved. The complexity of these systems is that they need to be synchronized (spin together without causing any distortion to the substrate). This is achieved by using two different stepper motors driven by the same pulses coming out of a drive module.

The inverter system is capable of lowering the substrate prior to rotating the substrate while avoiding a collision within the dispense position with the dispensing unit and/or gantry. While rotating a substrate in one lane, the dispensing unit of the dispenser can continue to dispense on a substrate located in an adjacent lane. The inverter system includes linear motion devices having linear bearings, ball screws and stepper motors to drive them. The roller system is configured to enable the dispensing unit to get close to the edge of the substrate since there is very little space for the dispensing unit to effectively operate. The roller system positions the substrate at a dispense height regardless of an orientation and a thickness of the substrate. The roller system is configured to secure the substrate effectively during rotation of the substrate. The roller system further is configured to be rigid and align tightly in both orientations and at transport and dispense heights.

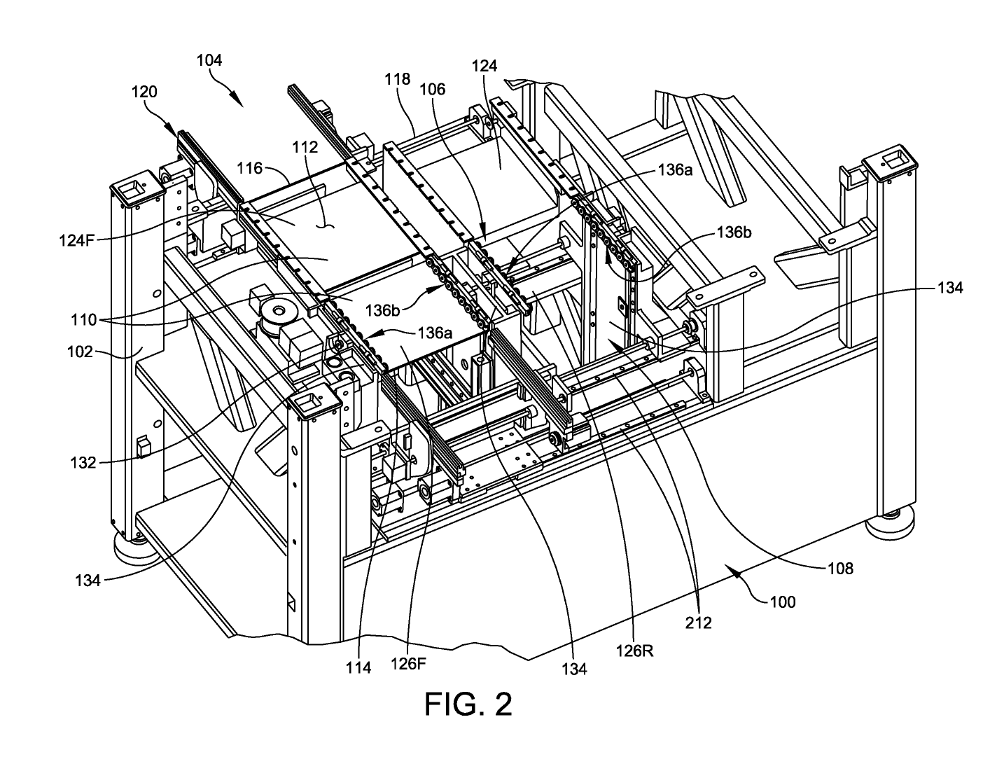

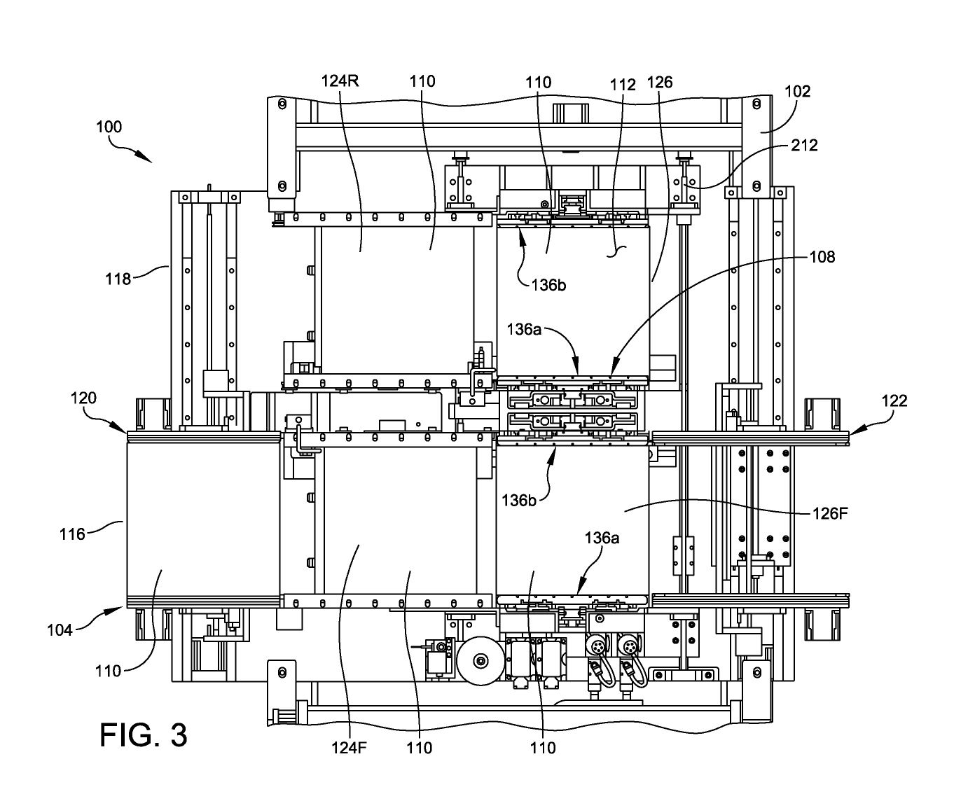

Referring to the drawings, and more particularly to FIGS. 2 and 3, a dispenser of an embodiment of the present disclosure is generally indicated at 100. As shown, the dispenser includes a frame 102, which supports the systems and components of the dispenser, including a transport system generally indicated at 104, which shuttles substrates into and out of the dispenser, a roller system generally indicated at 106, which moves and secures the substrates during processing, and an inverter system generally indicated at 108, which operates with the roller system to invert or flip over the substrates to dispense material on both sides of the substrates. Substrates are indicated at 110 throughout the drawings, with a top surface of the substrate being designated at 112 and a bottom surface of the substrate being designated at 114. Each system includes subassemblies that interact with subassemblies of other systems and other components of the dispenser 100 to move substrates 110 into and out of the dispenser and to dispense material on the substrates. A controller associated with the dispenser is configured to control the operation of the systems of the dispenser. In one embodiment, the controller is similar to and provides the functionality of controller 18 of dispenser 10.

FIGS. 2 and 3 illustrate the frame 102 and the transport system 104 configured to move substrates along two parallel transport paths, a front transport path 116 located toward a front of the dispenser 100 and a rear transport path 118 located toward a rear of the dispenser. The transport system 104 includes a first, upstream conveyor system generally indicated at 120 provided on the left-hand side of the dispenser 100, which is configured to deliver substrates 110 to the front and rear transport paths 116, 118. Specifically, the upstream conveyor system 120 includes a movable conveyor that is configured to move between a first position in which the movable conveyor is aligned with the front transport path 116 and a second position in which the movable conveyor is aligned with the rear transport path 118. FIGS. 2 and 3 show the movable conveyor of the upstream conveyor system 120 in its first position in which the upstream conveyor system is aligned with the front transport path 116. The transport system 104 further includes a second, downstream conveyor system generally indicated at 122 provided on the right-hand side of the dispenser 100, which is configured to remove substrates 110 from the front and rear transport paths 116, 118. As with the upstream conveyor system 120, the downstream conveyor system 122 includes a movable conveyor that is configured to move between a first position in which the movable conveyor is aligned with the front transport path 116 and a second position in which the movable conveyor is aligned with the rear transport path 118. FIGS. 2 and 3 show the movable conveyor of the downstream conveyor system 122 in its first position in which the downstream conveyor system is aligned with the front transport path 116.

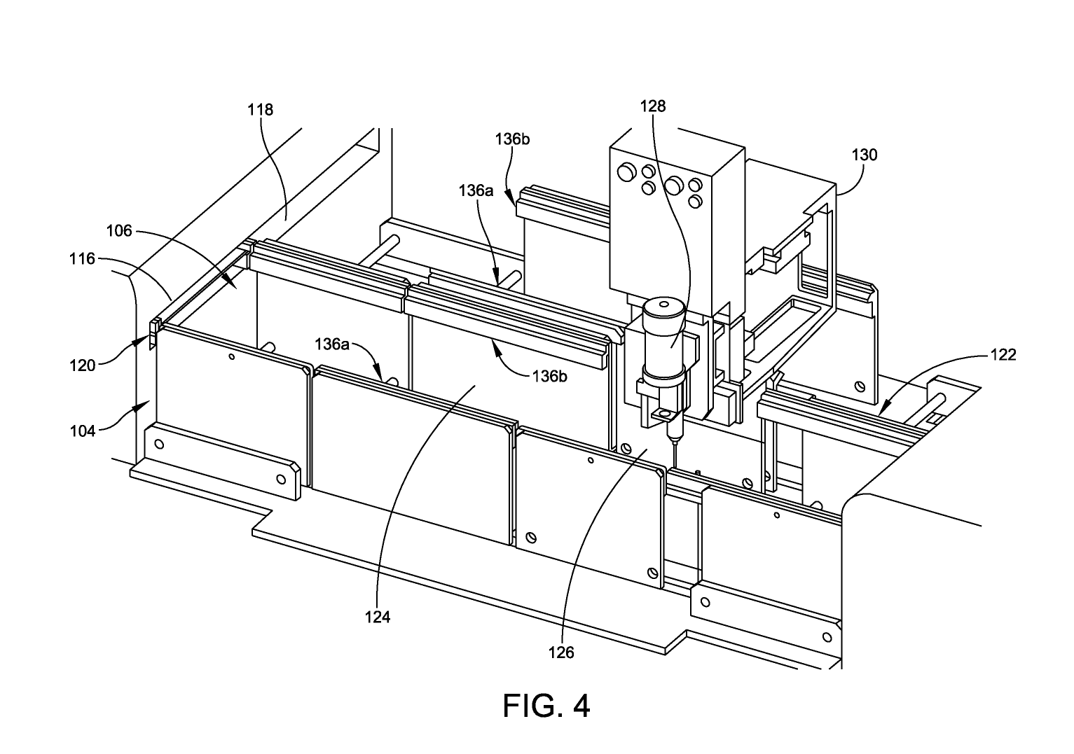

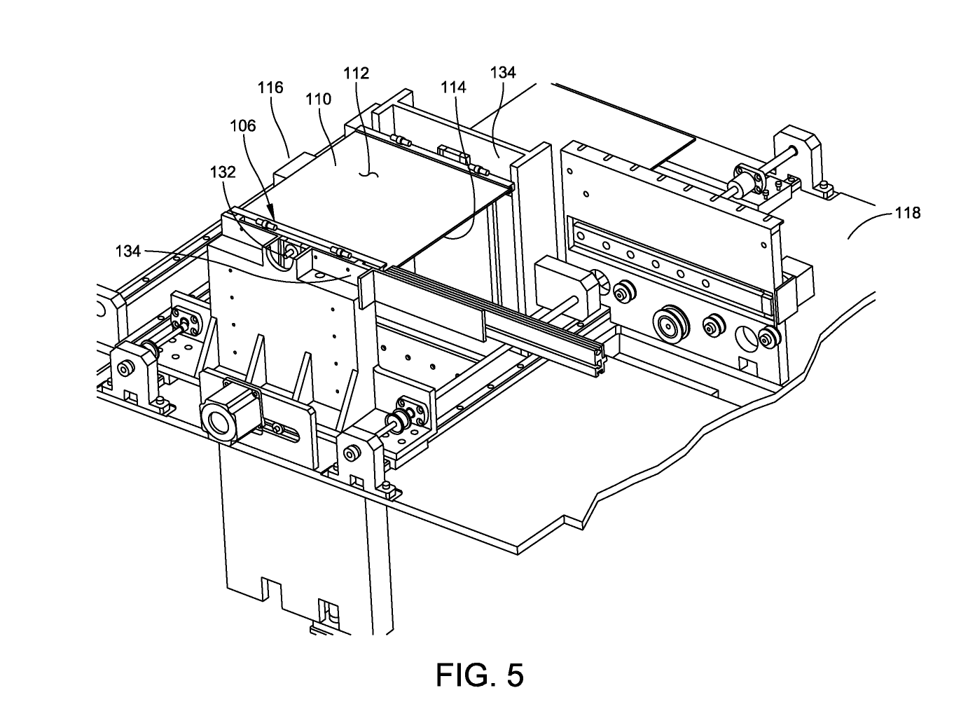

With additional reference to FIGS. 4 and 5, for each transport path 116, 118, substrates 110 are delivered to the upstream conveyor 120 by an upstream system, such as a shuttle loader, to a pre-heat position 124 configured to heat the substrate prior to dispensing. The dispenser 100 includes a pre-heat chuck associated with the front transport path 116 and the rear transport path 118. Conventional belt drives are used to move the substrate within the pre-heat zone. The substrates 110 are then moved from the pre-heat position 124 to a dispense position 126 in which the substrates are positioned under a dispensing unit 128, which is attached to a dispensing unit gantry 130 to move the dispensing unit in the x-axis, y-axis, and z-axis directions. FIGS. 2 and 3 illustrate the pre-heat and dispense positions 124F, 124R associated with the front transport path and the pre-heat and dispense positions associated with the rear transport path 124R, 126R. As will be described in greater detail below, for each of the front transport path 116 and the rear transport path 118, the dispensing unit 128 is capable of dispensing material, such as solder paste, on both sides of the substrate 110, with the roller system 106 holding the substrate in place during the dispensing operation. After dispensing, the substrates 110 are removed from the dispense position 126 by the downstream conveyor system 122 to a downstream system, such as a pick-and-place machine or another dispenser.

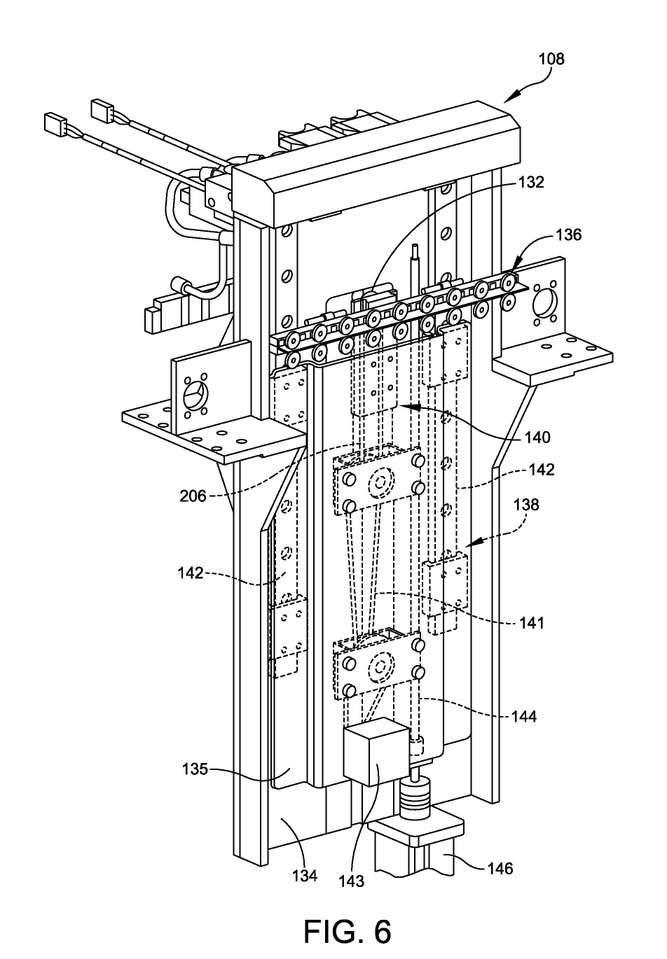

FIG. 6 illustrates the inverter system 108 apart from the remaining components of the dispenser 100. The inverter system 108 is configured to move in a z-axis direction with respect to the frame 102 to rotate the roller system 106 about an axis that is parallel to a y-axis direction between a first position in which a top surface 112 of the substrate 110 is in a dispense position under the dispensing unit 128 and a second position in which a bottom surface 114 of the substrate is in a dispense position. The inverter system 108 is further configured to rotate about a pivot 132 to invert the substrate 110 so that a dispense operation may take place on the bottom surface 114 of the substrate.

As shown, for each side of the substrate, the inverter system 108 includes a z-axis support plate 134 and a z-axis elevator plate 135 movably mounted on the support plate. The elevator plate 135 has a roller assembly generally indicated at 136 of the roller system 106 mounted on an end of the elevator plate 135. The inverter system 108 further includes a z-axis drive assembly 138 that is configured to move the elevator plate 135 in the z-axis direction with respect to the support plate, and a rotational drive assembly 140 configured to rotate the roller assembly 106. The z-axis drive assembly 138 includes a pair of spaced-apart z-axis bearings 142, which are mounted on the support plate 134 and coupled to the elevator plate 135 by a z-axis ball screw 144 to move the elevator plate 135 upwards and downwards with respect to the support plate. The z-axis drive assembly 138 further includes a motor 146, which is configured to drive the rotation of ball screw 144. The arrangement is such that the inverter system 108 is capable of driving the up and down movement of the elevator plate 135, the purpose of which will become apparent as the description of the dispenser 100 proceeds. The rotational drive assembly 140 includes a belt 141 coupled to the pivot 132 and a motor 143 configured to drive the belt to rotate the pivot and the roller system 106.

Referring back to FIGS. 2 and 3, the roller system 106, for each transport path 116 118, includes a first roller assembly 136a having a plurality of rollers configured to secure one edge of the substrate 110 and a mating second roller assembly 136b having a plurality of rollers configured to secure an opposite edge of the substrate. The roller assemblies 136 are configured to deliver the substrate 110 to the dispense position 126, firmly secure the substrate during the dispensing and rotational operations, and to remove the substrate from the dispense position to the downstream conveyor system 122. Each roller assembly 136 includes a plurality of tapered rollers positioned to frictionally engage the edge of the substrate 110 to drive the movement of the substrate through the dispenser along the transport path 116 or 118.

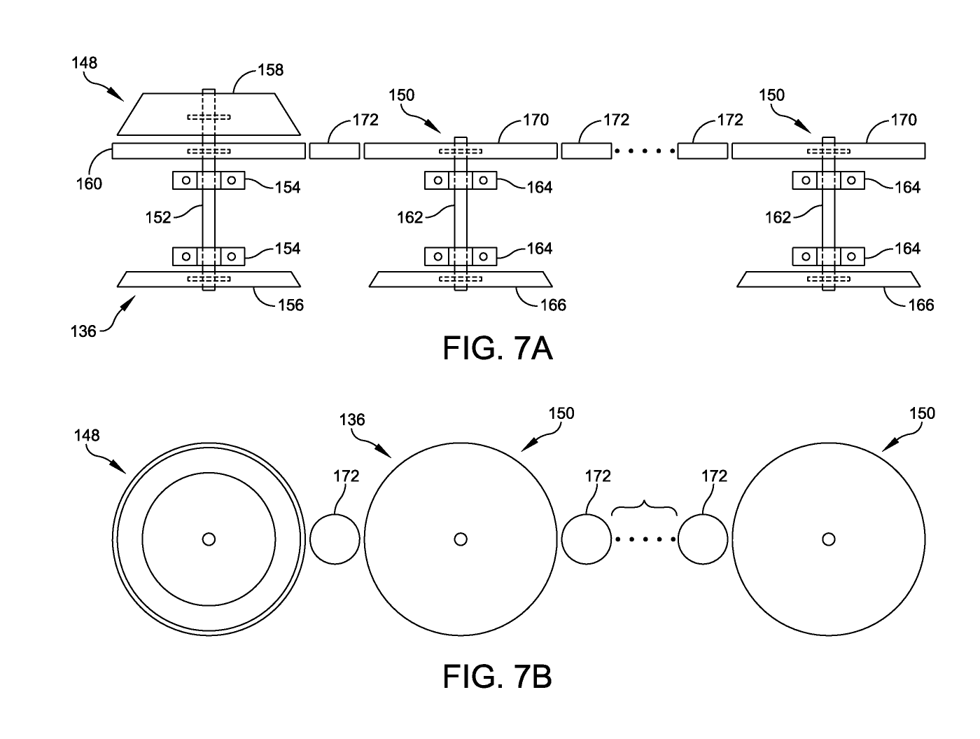

Referring to FIGS. 7A and 7B, which illustrates a roller assembly 136 provided at the dispense position 126, each roller assembly includes a primary friction drive wheel assembly generally indicated at 148 and a secondary friction drive wheel assembly generally indicated at 150, which are configured to engage an edge of the substrate when the substrate is delivered to, supported by, and removed from the dispense position. The primary friction drive wheel assembly 148 includes a drive shaft 152 supported by two bearings, each indicated at 154. The support bearings 154 are suitably mounted directly or indirectly on the frame 102 of the dispenser 100. The primary friction drive wheel assembly 148 further includes a tapered substrate friction wheel 156 mounted on one end of the drive shaft 152 and a tapered input motor drive friction wheel 158 mounted on an opposite end of the drive shaft. The primary friction drive wheel assembly 148 further includes a drive gear 160 that is provided to drive the secondary friction drive wheel assembly 150 in the manner described below. A suitable drive motor is provided to drive the rotation of the drive shaft 152 via the input motor drive gear 158.

Similarly, the secondary friction drive wheel assembly 150 includes a drive shaft 162 supported by two bearings, each indicated at 164. The support bearings 164 are suitably mounted directly or indirectly on the frame 102 of the dispenser 100. The secondary friction drive wheel assembly 150 further includes a tapered substrate friction wheel 166 mounted on one end of the drive shaft 162 and a driven gear 170 mounted on an opposite end of the drive shaft, which is driven by an idler gear 172 disposed between the drive gear 160 of the primary friction drive wheel assembly 148 and the driven gear of the secondary friction drive wheel assembly. As shown, the roller assembly 136 may include any number of secondary friction drive assemblies 150 and idler gears 172 to drive the movement of the substrate through the dispenser. It should be noted that although one roller assembly 136 is illustrated in FIGS. 7A and 7B to engage either the top edge or the bottom edge of the substrate, a mating roller assembly is provided to positively engage both sides of the substrate between the roller assemblies during breaking as well as transport of the substrate regardless of the orientation of the clamp.

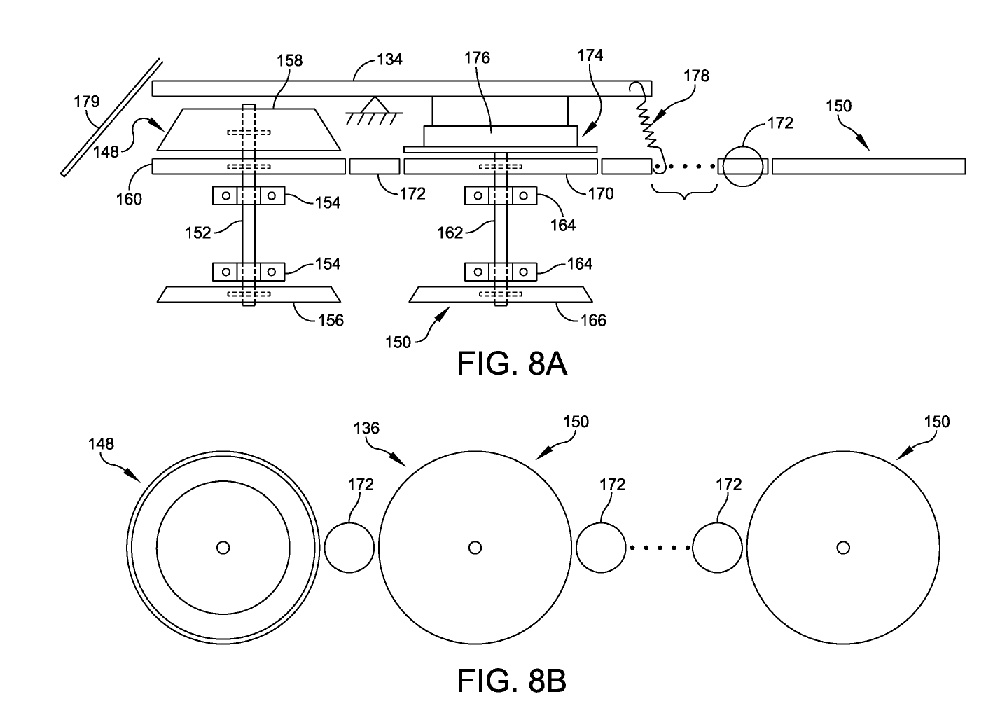

Referring to FIGS. 8A and 8B, the secondary friction drive wheel assembly 150 also includes a brake assembly, generally indicated at 174, which includes a friction brake 176 and a brake spring 178. When the elevator plate 135 of the inverter system 108 is in the transport height or raised position, the drive motor engages the friction wheel 158 and drives the rollers. Once the elevator plate 135 of the inverter system 108 drops down to the invert position, the motor will no longer be engaged with the friction wheel 158. Thus, when the inverter system 108 starts to rotate, the substrate would back drive drives the rollers so that the rollers would spin. Without the brake assembly 174, the substrate will fall out of the roller system 106 and onto the bottom of the dispenser. The purpose of the brake assembly 174 is that when the roller system 106 is at any position other than the transport/dispense position, the rollers will be locked from rotating. The assembly has an activation lever 179, which is spring biased by the brake spring 178 to lock the brake except when the lever engages the brake arm 134 and causes it to pivot to disengage. As shown, the roller assembly 136 may include any number of secondary friction drive assemblies 150 and idler gears 172 to drive the movement of the substrate through the dispenser.

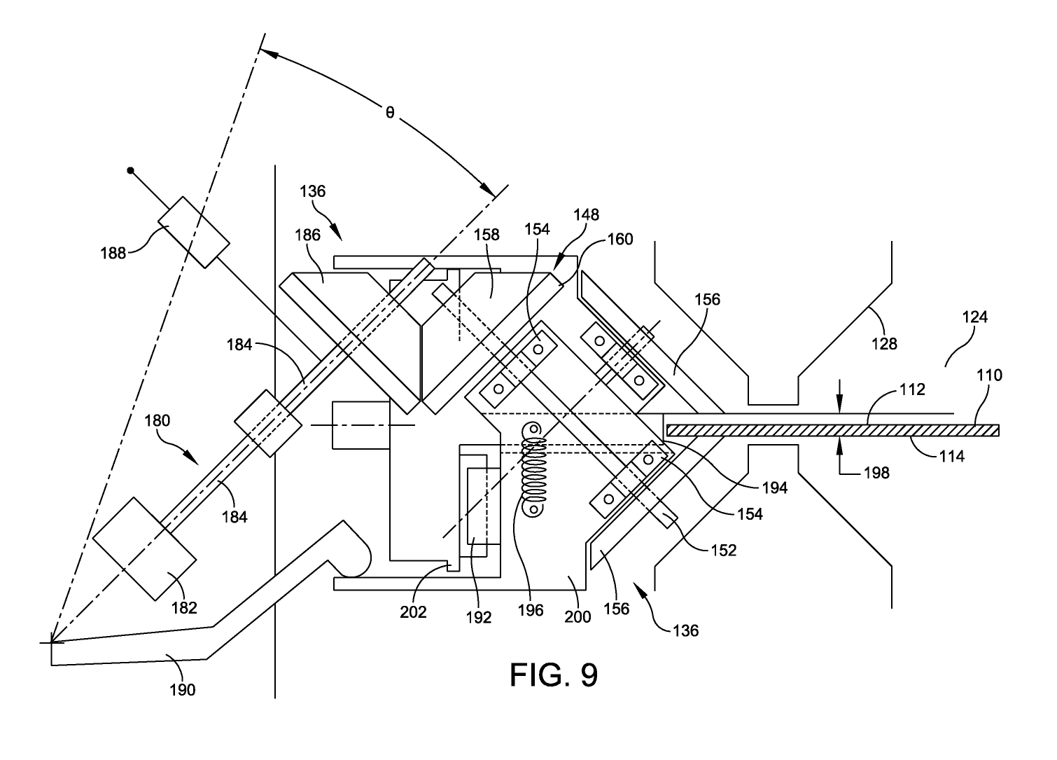

Referring to FIG. 9, which illustrates a portion of the roller assemblies 136 shown in FIGS. 7A and 7B, the lower substrate contact roller assembly 136 includes a drive assembly generally indicated at 180 that is configured to drive the rotation of the primary and secondary friction drive wheel assemblies 148, 150 of the roller assembly. The drive assembly 180 includes a motor 182 coupled to a shaft 184, the motor being configured to drive the rotation of the shaft. The drive assembly 180 is configured to engage the roller assembly 136 when the inverter system 108 is in the raised transport position and to disengage the roller assembly when the inverter system is in the lowered position.

The drive assembly 180 further includes a friction drive wheel 186 that mates with the friction drive wheel 158 of the primary friction drive wheel assembly 148. The arrangement is such that the drive assembly 180, which is coupled to the controller of the dispenser 100, drives the movement of the primary friction drive wheel assembly 148 to move the substrate 110 through the dispense position 126. The drive assembly 180 further includes an actuator 188 that is configured to move the friction drive assembly 180 into and out of engagement with the friction drive wheel 158. A stop may be provided to limit the movement of the actuator 188. In one embodiment, the actuator may be an air cylinder, however, other actuators may be provided. The drive assembly 180 further includes a substrate release lever 190, which acts on the lower contact roller assembly to open up the roller assembly.

The drive assembly further includes a linear bearing 192 to enable relative motion between each of the roller assemblies relative to the pivot 132 and a board guide edge 194 of the roller assembly 136. The drive assembly further includes a spring 196, which provides the clamping force of the roller assemblies on the substrate. Reference numeral 198 indicates a dimension, which shows a maximum opening of the roller assembly 136 to receive a substrate. Components of the roller assembly 136 and the drive assembly 180 are supported by a frame 200 for the lower roller assembly. A stop 202 is provided to engage the lower roller assembly when the release lever 190 is disengaged and the spring 196 biases the roller assembly.

As shown, the spring 196 raises the frame 200 to bring the top side of the substrate to a clamped position between the rollers. The substrate release lever 190 swings through the theta arc to release the rollers to bring the bottom surface of the substrate to the transport position. The drive assembly 180 is actuated by actuator 188 and swings through the theta arc to drive the friction wheel 156 of the rollers to enable the substrate to run into and out of the rollers. The drive assembly 180 and release lever 190 are then retracted and the substrate is dispensed and then rotated to the bottom side. After the bottom side is dispensed, A second set of rollers and a roller drive assembly that is used to convey substrates when the clamp/roller assembly is at 180 degrees rotation. The substrate release lever 190 swings through the theta arc to release the rollers to bring the bottom surface of the substrate to the transport position. The drive assembly 180 is actuated by actuator 188 and swings through the theta arc to drive the roller assembly of the rollers to enable the substrate to run into and out of the rollers. This process repeats itself.

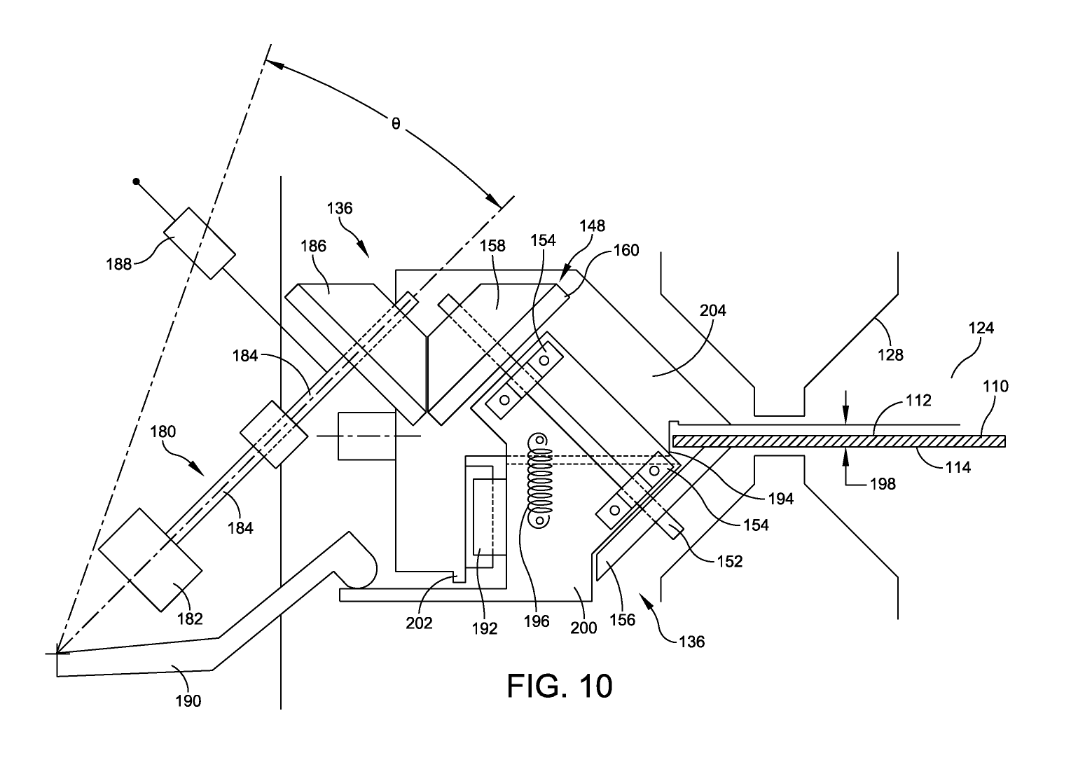

FIG. 10 illustrates a roller assembly 136 and drive assembly 180 that is similar to the assemblies shown in FIG. 9. The embodiment shown in FIG. 9 provides a better cycle time, as it can transport substrates with either side face up. This assembly shown in FIG. 10 includes a fixed clamp 204, which is configured to transport the substrates if the roller assembly is on the bottom side. This means there will need to be an extra 180 degree rotation to flip the substrate back to the original side and convey the substrate out of the machine. This embodiment would use a simple piece of metal as the fixed clamp 204 in place of the contact point of the rollers, which is essentially one part of a clamp.

Referring back to FIGS. 4-6, the inverter system 108 is capable of rotating the substrate 110 so that the bottom surface 114 of the substrate faces upwardly so that the dispensing unit 128 can dispense material on the bottom surface. During an inversion process, the substrate 110 is lowered by the inverter system 108 to an inversion position. In a certain embodiment, a maximum size of the substrate 110 is approximately ten inches by ten inches. Thus, for a substrate 110 having a length and width of ten inches by ten inches, a rotation path of the substrate would be ten inches wide and ten inches long. The arrangement is such that the substrate is secured by the roller system 106, with roller assemblies 136 being lowered so that the rollers or wheels engage the substrate securely. Once in the lowered position, otherwise referred to as an inversion position, the inverter system 108 rotates the roller assemblies 136 so that the bottom surface 114 of the substrate 110 faces upwardly.

In one embodiment, to rotate the roller assemblies 136, the rotational drive assembly of the inverter system 108 may include a belt, e.g., belt 141, connected to the pivot 132 of the frame structure of the roller assembly. The belt is driven by a suitable motor, e.g., motor 143. In one embodiment, the drive assembly achieves a 10:1 drive ratio. The pivot 132 fits into a bearing that is mounted to the moving z-axis elevator plate 135. The pivot 132 may include a pulley that mounted near an end of the pivot, with the belt driving the rotation of the roller assembly 136. As shown, the dispenser 100 includes at each side of the substrate a support plate 134, an elevator plate 135, a roller assembly 136, and a rotational drive assembly 140 that operate together in a synchronized manner to secure and rotate the substrate 110.

In some embodiments, to adjust a transport width, linear bearings may be provided at a transport width of the dispenser 100. Just above the linear bearings are ball screws, which drive the transport width by a motor and a belt drive from the rear. There is a junction point between the two ball screws, a right hand screw and a left hand screw. The provision of two ball screws enables a width of both lanes to be simultaneously moved to the same substrate size. A motor drive assembly is provided to adjust the transport width. The motor drive assembly includes two belt pulleys, which are provided on ball screws.

During operation, the upstream conveyor system delivers substrates to the front and rear transport paths through the dispenser. Specifically, the movable conveyor of the upstream conveyor system is aligned with one of the transport paths, e.g., the front transport path, to deliver the substrate to the pre-heat position. Once in the pre-heat position, the substrate is moved to the dispense position by the heat zone belt drive system and the substrate roller system of the transport system. The dispensing unit performs a dispense operation on the top surface of the substrate. When completed, the substrate is lowered, rotated so that the bottom surface of the substrate faces upwardly, and raised to the dispense position by the inverter system. The dispensing unit then performs a dispense operation on the bottom surface of the substrate. When completed, the substrate is removed from the dispense position by the roller system and the movable conveyor of the downstream conveyor system.

After delivering the substrate, the movable conveyor of the upstream conveyor system receives another substrate, and moves so that the upstream conveyor system is aligned with the other transport path, e.g., the rear transport path, to deliver the substrate to the pre-heat position. This substrate travels from the pre-heat position to the dispense position in a similar manner, where a dispense operation can take place on both the top and bottom surfaces of the substrate. This substrate is also removed from the dispense position in a similar manner.

As discussed above, the foregoing operations may be controlled by a controller, such as controller 18 referenced with dispenser 10.

Having thus described at least one embodiment of the disclosure, various alternations, modifications and improvements will readily occur to those skilled in the art. Such alterations, modifications and improvements are intended to be within the scope and spirit of the disclosure. Accordingly, the foregoing description is by way of example only and is not intended to be limiting. The limit is defined only in the following claims and equivalents thereto.

What is claimed is:

1. A dispenser for dispensing viscous material on a substrate having a top surface and a bottom surface, the dispenser comprising:
a frame;
a gantry system coupled to the frame;
a dispensing unit coupled to the gantry system, the gantry system being configured to move the dispensing unit in x-axis, y-axis, and z-axis directions; and
a substrate support assembly coupled to the frame and configured to support the substrate to dispense material on the top surface of the substrate and on the bottom surface of the substrate, the substrate support assembly including
a roller system configured to receive and support the substrate in a dispense position, and
an inverter system coupled to the frame and the roller system, the inverter system being configured to rotate the roller system about an axis that is parallel to the y-axis direction between a first position in which the top surface is in a dispense position and a second position in which the bottom surface is in a dispense position.

2. The dispenser of claim 1, wherein the roller system includes a first roller assembly configured to engage one edge of the substrate and a second roller assembly configured to engage an opposite edge of the substrate.

3. The dispenser of claim 2, wherein, for each of the first roller assembly and the second roller assembly, the rotational drive assembly includes a pivot secured to the roller assembly, a belt coupled to the pivot, and a motor configured to drive the belt to rotate the pivot.

4. The dispenser of claim 2, wherein each roller assembly includes a plurality of rollers configured to engage an edge of the substrate and a drive assembly configured to drive the rotation of the rollers.

5. The dispenser of claim 4, wherein at least one roller of the plurality of rollers is tapered along a periphery of the roller.

6. The dispenser of claim 2, wherein each roller assembly includes a brake assembly configured to prevent the rotation of rollers associated with the roller assembly.

7. The dispenser of claim 1, wherein the inverter system further is configured to move in a z-axis direction.

8. The dispenser of claim 7, wherein the inverter system further includes a support plate, an elevator plate movably coupled to the support plate, a z-axis drive assembly configured to move the elevator plate in the z-axis direction.

9. The dispenser of claim 8, wherein the z-axis drive assembly includes at least one bearing coupled to the frame by a ball screw, and a motor configured to drive the rotation of the ball screw to move the elevator plate with respect to the support plate.

10. The dispenser of claim 1, wherein the inverter system includes a rotational drive assembly configured to rotate the roller system.

11. The dispenser of claim 1, wherein the substrate support assembly includes two lanes, a front lane and a rear lane, and wherein the dispenser further comprises an upstream conveyor system configured to deliver substrates to the front and rear lanes of the dispenser.

12. The dispenser of claim 11, further comprising a downstream conveyor system configured to remove substrates from the front and rear lanes of the dispenser.

13. A method of depositing material on a top surface of a substrate and on a bottom surface of the substrate, the method comprising:
delivering the substrate to a substrate support assembly of a dispenser, the substrate support assembly including a roller system configured to receive and support the substrate in a dispense position, and an inverter system coupled to the frame and the roller system, the inverter system being configured to rotate the roller system about an axis that is parallel to the y-axis direction between a first position in which the top surface is in a dispense position and a second position in which the bottom surface is in a dispense position;
performing a dispense operation on the top surface of the substrate;
rotating the substrate so that the bottom surface of the substrate faces upwardly;
performing a dispense operation on the bottom surface of the substrate; and
removing the substrate from the substrate support assembly of the dispenser.

14. The method of claim 13, further comprising, prior to rotating the substrate, lowering the substrate, disengaging a drive assembly associated with the roller system.

15. The method of claim 14, further comprising locking the substrate within the roller system with a brake assembly.

16. The method of claim 14, further comprising, raising the substrate prior to performing a dispense operation on the bottom surface of the substrate.

17. The method of claim 13, wherein delivering the substrate to the substrate support assembly of the dispenser includes delivering the substrate to the dispense position through a first lane, and wherein the method further comprises delivering another substrate to the substrate support assembly of the dispenser through a second lane.

18. The method of claim 13, wherein the roller system includes a plurality of rollers configured to engage an edge of the substrate and a drive assembly configured to drive the rotation of the rollers.

19. The method of claim 18, wherein at least one roller of the plurality of rollers is tapered along a periphery of the roller.
